(19) United States
(12) Patent Application Publication
(10) Pub. No.: US 2024/0378422 A1
(43) Pub. Date: Nov. 14, 2024

(54) MULTI-VARIATE COUNTERFACTUAL DIFFUSION PROCESS

(71) Applicant: FAIR ISAAC CORPORATION, Roseville, MN (US)

(72) Inventors: Scott Michael Zoldi, San Diego, CA (US); Krzysztof Nalborski, San Diego, CA (US)

(21) Appl. No.: 18/316,987

(22) Filed: May 12, 2023

(51) Int. Cl. G06N 3/045; G06N 3/08

(52) U.S. Cl. CPC G06N 3/045; G06N 3/08

(57) ABSTRACT

A method is provided for multivariate counterfactual diffusion in desensitizing behavior latent features learned on limited data. The method includes generating a plurality of synthetic vectors for each input vector of a plurality of input vectors used to train a first machine learning model, where the plurality of synthetic vectors represent potential counterfactuals associated with the corresponding input vector. The method also includes filtering the plurality of synthetic vectors to identify counterfactual synthetic vectors. The method further includes predicting, by a second machine learning model trained based on the plurality of input vectors and the filtered plurality of counterfactual synthetic vectors, a classification of at least one input vector of the plurality of input vectors. Related methods and articles of manufacture are also disclosed.

### FIELD

The present disclosure generally relates to machine learning and more specifically to a multi-variate counterfactual diffusion process.

### BACKGROUND

Machine learning models, such as neural networks, may be used in critical applications such as in the healthcare, manufacturing, transportation, financial, information technology industries, among others. To allow companies to gain their customers' trust while meeting regulatory requirements, machine learning and artificial intelligence-based systems need to be built robustly and deployed with transparency and accountability. To do so, understanding the training data used to train machine learning models, and using high quality training data to train such machine learning models, can be important, and in some instances required. However, in certain scenarios and/or depending on the application, the available training data may be insufficient or otherwise inadequate for building responsible machine learning models.

### SUMMARY

Methods, systems, and articles of manufacture, including computer program products, are provided for a multi-variate counterfactual diffusion process. In one aspect, there is provided a system. The system may include at least one processor and at least one memory. The at least one memory may store instructions that result in operations when executed by the at least one processor. The operations may include: generating a plurality of synthetic vectors for each input vector of a plurality of input vectors used to train a first machine learning model. The plurality of synthetic vectors represent potential counterfactuals associated with the corresponding input vector. The operations also include filtering the plurality of synthetic vectors based at least on a comparison between a first score generated by the first machine learning model based on a first input vector of the plurality of input vectors and a second score generated by the first machine learning model based on a first synthetic vector of the plurality of synthetic vectors corresponding to the first input vector. The operations also include predicting, using a second machine learning model trained based on the plurality of input vectors and the filtered plurality of counterfactual synthetic vectors, a classification of at least one input vector of the plurality of input vectors.

In another aspect, there is provided a method. The method includes: generating a plurality of synthetic vectors for each input vector of a plurality of input vectors used to train a first machine learning model. The plurality of synthetic vectors represent potential counterfactuals associated with the corresponding input vector. The method also include filtering the plurality of synthetic vectors based at least on a comparison between a first score generated by the first machine learning model based on a first input vector of the plurality of input vectors and a second score generated by the first machine learning model based on a first synthetic vector of the plurality of synthetic vectors corresponding to the first input vector. The method also include predicting, using a second machine learning model trained based on the plurality of input vectors and the filtered plurality of counterfactual synthetic vectors, a classification of at least one input vector of the plurality of input vectors.

In another aspect, there is provided a computer program product including a non-transitory computer readable medium storing instructions. The operations include generating a plurality of synthetic vectors for each input vector of a plurality of input vectors used to train a first machine learning model. The plurality of synthetic vectors represent potential counterfactuals associated with the corresponding input vector. The operations also include filtering the plurality of synthetic vectors based at least on a comparison between a first score generated by the first machine learning model based on a first input vector of the plurality of input vectors and a second score generated by the first machine learning model based on a first synthetic vector of the plurality of synthetic vectors corresponding to the first input vector. The operations also include predicting, using a second machine learning model trained based on the plurality of input vectors and the filtered plurality of counterfactual synthetic vectors, a classification of at least one input vector of the plurality of input vectors.

In some variations, one or more features disclosed herein including the following features can optionally be included in any feasible combination of the system, method, and/or non-transitory computer readable medium.

In some variations, the plurality of synthetic vectors are generated based on a Gaussian distribution associated with each input vector.

In some variations, the filtering includes: generating, by the first machine learning model and based at least on the first input vector, the first score. The filtering also includes generating, by the first machine learning model and based at least on the first synthetic vector, the second score. The filtering also includes determining a difference between the first score and the second score. The filtering also includes determining to include the first synthetic vector in the filtered plurality of synthetic vectors based at least on the difference between the first score and the second score meeting a threshold difference.

In some variations, the filtering further includes identifying a synthetic vector of the plurality of synthetic vectors having a highest absolute residual value among the plurality of synthetic vectors for each input vector. The synthetic vector having the highest absolute residual value indicates a boundary of a data manifold associated with each input vector.

In some variations, determining to include the first synthetic vector in the filtered plurality of counterfactual synthetic vectors is further based on an angle between the first synthetic vector and the synthetic vector having the highest absolute residual value meeting a threshold angle.

In some variations, the angle is a cosine distance, and the threshold angle is a threshold cosine distance.

In some variations, the filtering includes: iteratively determining to include a synthetic vector of the plurality of synthetic vectors for each input vector in the filtered plurality of counterfactual synthetic vectors until a threshold quantity of synthetic vectors is included in the filtered plurality of counterfactual synthetic vectors.

In some variations, the method includes training the first machine learning model based on the plurality of input vectors and training the second machine learning model based on the plurality of input vectors and the filtered plurality of counterfactual synthetic vectors.

In some variations, the first machine learning model is a first neural network, and the second machine learning model is a second neural network.

Implementations of the current subject matter can include methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more processors residing in a single computing system or multiple computing systems. Such multiple computing systems can be connected and can exchange data and/or commands or other instructions or the like via one or more connections, including, for example, to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to generating explanations for single modal latent feature activation using first-to-saturate latent features in machine learning, it should be readily understood that such features are not intended to be limiting. The claims that follow this disclosure are intended to define the scope of the protected subject matter.

### DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 depicts an example diffusion system, consistent with implementations of the current subject matter;

FIG. 2 depicts an example process for classifying input vectors, consistent with implementations of the current subject matter;

FIG. 3 depicts an example vector distribution, consistent with implementations of the current subject matter;

FIG. 4 depicts a flowchart illustrating an example of a process for multi-variate counterfactual diffusion process, consistent with implementations of the current subject matter;

FIG. 5 depicts an example performance evaluation, consistent with implementations of the current subject matter;

FIG. 6 depicts a block diagram illustrating an example of a computing system, consistent with implementations of the current subject matter.

When practical, like labels are used to refer to same or similar items in the drawings.

### DETAILED DESCRIPTION

Training machine learning models, such as neural networks can be challenging. Generally, the main objective of the training process is to learn the mapping of feature vectors to their corresponding labels. During training of the machine learning models, the neural network's weights can be iteratively updated using, for example, backpropagation to minimize errors as computed by a loss function. This optimization problem can be very difficult to solve because the loss function's surface is generally very high dimensional and irregular, leading to difficulties in determining an optimal set of weights. Depending on the architecture of the machine learning model in terms of the number of hidden layers and hidden nodes, a set(s) of weights can be represented by a high number of parameters. For these reasons, neural networks have high degrees of freedom, and their training is considered nondeterministic polynomial-time complete.

With the evolution of new products, such as in the healthcare, manufacturing, transportation, financial (e.g., banking, lending, credit), and information technology industries, limited access to high-quality data with high binary class coverage (e.g., “good” and “bad” labels in transactional domains) can lead to challenges in building “responsible” supervised models (e.g., neural networks) for solving certain classification problems. The limited data often results in insufficient data samples to prevent over-fitting.

Neural networks also generally require vast amounts of high quality data to reach strong generalization ability. Without sufficient high quality data, over-fitting may occur, such as when a neural network is unable to generalize based on future data because the model learned the representation of the training feature set without the ability to account for even slight deviations in the values of the feature vector. This can lead to incorrect output prediction. For scenarios involving datasets of small size and with small class representation, over-fitting cannot be easily prevented.

Consistent with implementations of the current subject matter, the multi-variate counterfactual diffusion system described herein generates a new hardened training dataset that emphasizes the learned manifolds of an initial machine learning model to provide a more robust data set. For example, the system described herein generates a plurality of synthetic vectors for each input vector (later referred as a reference vector) of a plurality of input vectors used to train the first machine learning model. The plurality of synthetic vectors may represent counterfactuals associated with the corresponding reference or input vector. Counterfactual exemplars represent new training vectors that augment feature space manifold with no change in prediction outcome as compared to the original vector around which the counterfactual vectors were produced. These new vectors increase the diversity of the training dataset because they are slightly modified versions of the vectors already included in data corpus.

To select the counterfactuals included in the dataset (e.g., an out-of-time data set) used to train a second machine learning model, the system may filter the plurality of synthetic vectors based at least on a comparison between scores generated by the first machine learning model based on the reference vector and a plurality scores of the plurality of synthetic vectors. The system may then robustly predict a classification of at least one input vector of the plurality of input vectors from out-of-time data set using a second machine learning model trained based on the plurality of input vectors and the filtered plurality of counterfactual synthetic vectors representing counterfactuals.

The multi-variate counterfactual diffusion system generates new training vectors with the same (or similar) prediction as a reference vector according to the first machine learning model, but with significant changes in the feature values. The augmented data with synthetic vectors representing counterfactuals acts to strengthen dominant data manifolds learned by the first machine learning model, and when used to train a second machine learning model it allows for desensitizing of non-important feature variation with respect to learned data manifolds by the first machine learning model. This helps to prevent over-fitting and facilitates training of a more robust second machine learning model.

Further, consistent with implementations of the current subject matter, hardening of the original dataset with counterfactuals and training a new (e.g., second) machine learning model results in more consistent decisions with less sensitivity to noise. Counterfactual synthetic vectors represent new training vectors that augment the feature space manifold with no (or minimal) change in prediction outcome compared with the original reference vector around which the counterfactual synthetic vectors were produced. In other words, the generated counterfactual synthetic vectors capture changes within data inputs that do not materially impact the prediction generated based on the original reference vector.

These newly generated synthetic vectors increase the diversity of the training dataset because the synthetic vectors are modified versions of the input vectors already included in data corpus. Consequently, the synthetic vectors, consistent with implementations of the current subject matter, help train a machine learning model (e.g., the second machine learning model) to reduce its reliance on spurious and insignificant correlations during training. Generating counterfactual synthetic vectors that emphasize movement in some data features as not significant may also allow the second machine learning model to be trained to ignore small data correlations learned from the original small data corpus. Accordingly, the system described herein may offer improved results, such as when dealing with datasets of small size and with small class representation, as evaluated on an out-of-time data sample.

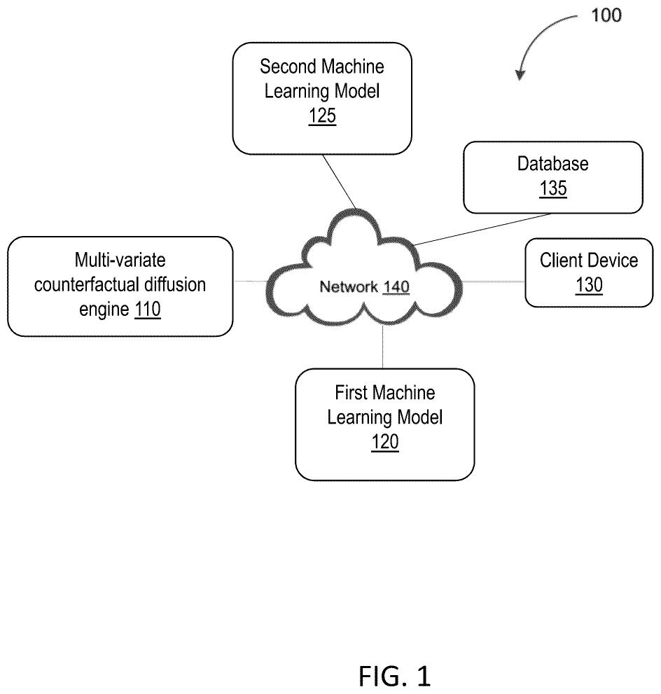

FIG. 1 depicts a system diagram illustrating an example of a multi-variate counterfactual diffusion system 100, consistent with implementations of the current subject matter. Referring to FIG. 1, the diffusion system 100 may include a multi-variate counterfactual diffusion engine 110, a first machine learning model 120, a second machine learning model 125, a database 135, and a client device 130. The diffusion engine 110, the first machine learning model 120, the second machine learning model 125, the database 135, and the client device 130 may be communicatively coupled via a network 140. The network 140 may be a wired network and/or a wireless network including, for example, a wide area network (WAN), a local area network (LAN), a virtual local area network (VLAN), a public land mobile network (PLMN), the Internet, and/or the like. In some implementations, the diffusion engine 110, the first machine learning model 120, the second machine learning model 125, the database 135, and/or the client device 130 may be contained within and/or operate on a same device. It should be appreciated that the client device 130 may be a processor-based device including, for example, a smartphone, a tablet computer, a wearable apparatus, a virtual assistant, an Internet-of-Things (IoT) appliance, and/or the like.

The diffusion engine 110 includes at least one data processor and at least one memory storing instructions, which when executed by the at least one data processor, perform one or more operations as described herein. The diffusion engine 110 may include a machine learning engine. The diffusion engine 110 may train the first machine learning model 120 based on input data including one or more input vectors (e.g., a plurality of input vectors). Additionally and/or alternatively, the diffusion engine 110 may train the second machine learning model 125 based on data including the one or more input vectors (e.g., a plurality of input vectors) and one or more synthetic vectors (e.g., a plurality of synthetic vectors) generated by the diffusion engine 110, as described herein. In some implementations, the diffusion engine 110 generates a filtered plurality of counterfactual synthetic vectors for training the second machine learning model 125.

The first machine learning model 120 may include a neural network, and/or the like. The first machine learning model 120 may be referred to herein as a reference model or network, or a base model or network. The first machine learning model 120 may include an input, one or more (e.g., one or a plurality) of hidden nodes, which may also be referred to herein as hidden units, and an output node. The input of the first machine learning model 120 may include training or reference examples including a plurality of input features represented as a plurality of input vectors. Each input vector of the plurality of input vectors may include contain one or more values corresponding to the plurality of input features. The one or more input features may include transaction records, transaction types, information associated with the transaction records such as a time, date, or location, user information associated with a user performing the transaction, and/or the like.

The diffusion engine 110 may train the first machine learning model 120 based on the available input data, including the available input vectors. While the input data is generally described as being in the form of input vectors, “input vectors” is one example, as the input data may be represented in other forms. In some implementations, the available input data for training the first machine learning model 120 is sparse or limited. As noted, in some scenarios, such as during deployment of a new application or product, limited data may be available.

The diffusion engine 110 may train the first machine learning model 120 to generate the output, which may include a score, a classification of each input vector, and/or the like. The classification of the input vector may include a binary classification, such as a likely positive outcome (e.g., no disease or tumor, no fraud, etc.) or a likely negative outcome (e.g., likely existence of a disease or tumor, likely existence of fraud, etc.). In other words, based at least on at least one input vector, the diffusion engine 110 may train the first machine learning model 120 to classify the at least one input vector as likely indicating the positive outcome or the negative outcome.

The second machine learning model 125 may include a neural network, and/or the like. The second machine learning model 125 may include an input, one or more (e.g., one or a plurality) of hidden nodes, which may also be referred to herein as hidden units, and an output node. The input of the second machine learning model 125 may include training examples including the plurality of input features represented as a plurality of input vectors and a plurality of counterfactual synthetic vectors generated by the diffusion engine 110. Each synthetic vector of the plurality of synthetic vectors may include contain one or more values corresponding to the plurality of input features.

The diffusion engine 110 may train the second machine learning model 125 based on the available input data, including the available input vectors, and the generated synthetic counterfactual vectors. While the synthetic counterfactual data is generally described as being in the form of synthetic vectors, “synthetic vectors” is one example, as the synthetic data may be represented in other forms. Training the second machine learning model 125 based on both the input vectors and the generated synthetic vectors improves performance of the second machine learning model 125, such as relative to the second machine learning model 125.

The diffusion engine 110 may train the second machine learning model 125 to generate the output, which may include a score, a classification, and/or the like. The classification may include a binary classification, such as a likely positive outcome (e.g., no disease or tumor, no fraud, etc.) or a likely negative outcome (e.g., likely existence of a disease or tumor, likely existence of fraud, etc.). In other words, based at least on at least one input vector and/or synthetic vector, the diffusion engine 110 may train the second machine learning model 125 to classify the at least one input vector and/or synthetic vector as likely indicating the positive outcome or the negative outcome.

Referring back to FIG. 1, the database 135 may store one or more input data and/or output data, as described herein. For example, the database 135 may store input data, such as one or more input vectors and/or one or more generated counterfactual synthetic vectors. As noted, the one or more input features may be associated with a transaction and/or a user corresponding to the transaction. For example, the one or more input features may include may be real world and/or historical data collected based on transactions made by one or more entities. In some implementations, the one or more input features stored in the database 135 may include a customer, an account, a person, a credit card, a bank account, or any other entity whose behavior is being monitored and/or is otherwise of interest, and/or the like, a plurality of transactions (e.g., purchases, sales, transfers, and/or the like), a class (e.g., a credit default, a fraudulent card transaction, a money laundering transaction, and/or the like) assigned to each of the plurality of transactions, an entity associated with each of the plurality of transactions, a time point associated with each of the plurality of transactions, and/or the like. The stored data may additionally and/or alternatively include the classifications predicted by the first machine learning model 120 and/or the second machine learning model 125.

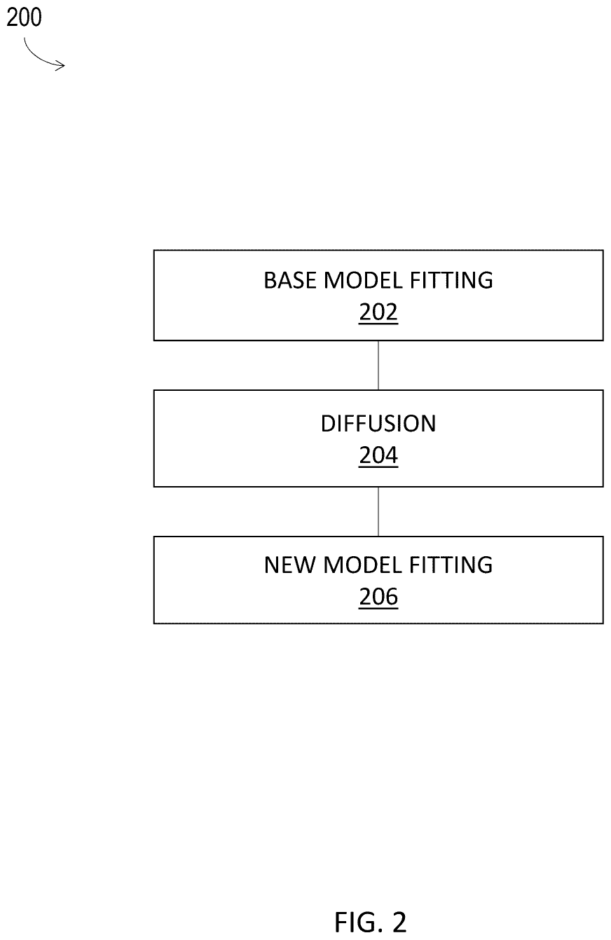

FIG. 2 illustrates an example process 200 for multi-variate counterfactual diffusion, consistent with implementations of the current subject matter. The process 200 may be implemented by the diffusion engine 110, and/or the like.

At 202, the diffusion engine 110 may fit the first machine learning model 120 (e.g., the base model). For example, the diffusion engine 110 may fit the first machine learning model 120 based on the small available data corpus (D), which includes the plurality of input vectors. Generally, this small available data corpus D is of high quality and is previously validated. In some implementations, as noted, the diffusion engine 110 may train the first machine learning model 120 based on the plurality of input vectors. The diffusion engine 110 may train the first machine learning model 120 to generate a score and/or classify the plurality of input vectors. This establishes a base model including a baseline weights, hyperparameters, feature set, and/or the like, which are set and stored.

At 204, the diffusion engine 110 may apply diffusion to generate a filtered plurality of counterfactual synthetic vectors. The main objective of the diffusion process is expanding the original small training data corpus (e.g., the plurality of input vectors) to dampen the data manifolds learned by first machine learning model 120. During the diffusion, at 204, new synthetic vectors are generated and added based on their multi-variate gradient movement and minimal or no score difference with respect to the original reference feature vector as evaluated by the initial neural network model (e.g., the first machine learning model 120).

For example, for each input vector of the plurality of input vectors, such as the plurality of input vectors used to train the first machine learning model 120, the diffusion engine 110 generates a plurality of synthetic vectors to further filter for counterfactual synthetic vectors. In some implementations, for each input vector in D, diffusion engine 110 generates the plurality of synthetic vectors as part of a neighborhood cloud of size S in the feature space. The neighborhood cloud size S may be predefined and may be increased or decreased to increase or decrease the quantity of initially-generated synthetic vectors for each input vector.

The diffusion engine 110 may generate the plurality of synthetic vectors based on a Gaussian distribution associated with each input vector. In other words, the newly generated synthetic vectors may be sampled from a multi-variate Gaussian distribution. Synthetic vectors fall into the real and likely value ranges for each feature from the original input vector. As an example, if the values of a given feature in the input vector are greater than or equal to zero, the neighborhood cloud for the input vector would not contain synthetic vectors with values that are less than zero for that feature.

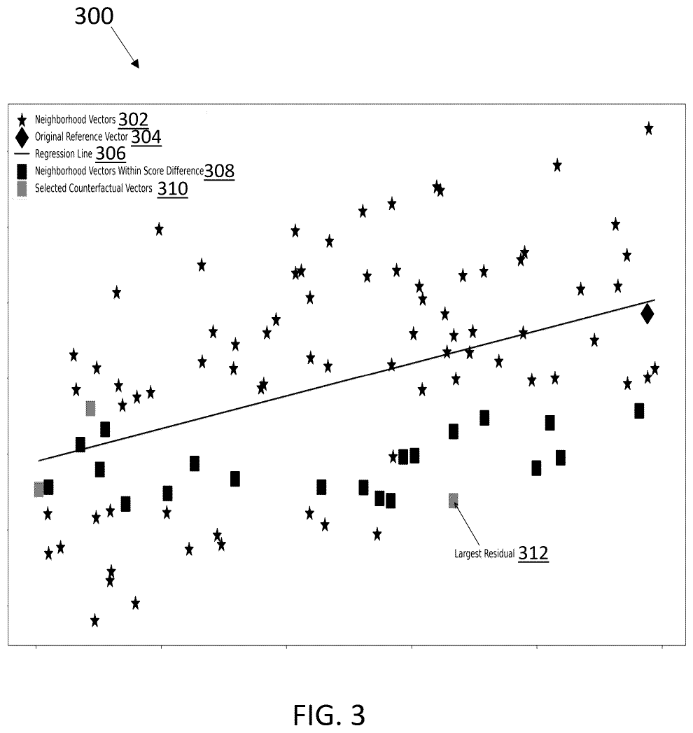

FIG. 3 depicts an example vector distribution 300, consistent with implementations of the current subject matter. As shown in FIG. 3, the distribution 300 includes an input vector (e.g., a first input vector) 304 from the plurality of input vectors. The input vector 304 is shown as an original reference vector. The distribution 300 also includes the original neighborhood cloud of synthetic vectors 302. The original neighborhood cloud of synthetic vectors 302 includes the originally-generated synthetic vectors sampled from the multi-variate Gaussian distribution prior to filtering the plurality of synthetic vectors.

The plurality of synthetic vectors may represent counterfactuals associated with a corresponding input vector of the plurality of input vectors. Consistent with implementations of the current subject matter, the counterfactuals may represent new training vectors (e.g., the synthetic vectors) that augment the feature space manifold of the first machine learning model 120 with no (or minimal) change in prediction compared with the original input vector around which the counterfactual synthetic vectors were produced. In other words, the generated counterfactual synthetic vectors capture changes within data inputs that do not materially impact the prediction generated by the first machine learning model 120 based on the original input vector.

Referring back to FIG. 2, the diffusion engine 110 uses the trained machine learning model 120 to generate a score for each input vector of the plurality of vectors. Additionally and/or alternatively, the diffusion engine 110 uses the trained machine learning model 120 to generate a score for each generated synthetic vector of the plurality of synthetic vectors corresponding to each input vector. A diffusion engine (which may be the same as or separate from the diffuse engine 110) fits a local linear regression model based at least on the generated scores associated with each input vector and their corresponding synthetic vectors (the scores are generated by the first machine learning model 120). An example regression line 306 representing the fitted local linear regression model is shown in FIG. 3. The example regression line 306 is a graphical representation of the local linear regression equation used to calculate the multi-variate gradient movement used to identify the maximum reach of the manifold in the feature space.

The diffusion engine 110 may select one or more generated counterfactual synthetic vectors (referred to herein as a filtered plurality of counterfactual synthetic vectors) for use in training the second machine learning model 125. To do so, the diffusion engine 110 may filter the generated plurality of synthetic vectors.

For example, the diffusion engine 110 may evaluate the differences in the generated scores between a particular vector (e.g., original reference vector 304 in FIG. 3.) and the generated synthetic vectors corresponding to the particular input vector. In other words, the diffusion engine 110 compares the difference between the score generated by the first machine learning model 120 for an input vector and the score for each of the synthetic vectors within the neighborhood cloud for that input vector. The diffusion engine 110 ignores (e.g., filters out) synthetic vectors from the neighborhood cloud for the particular input vector when the difference in score between those synthetic vectors and the particular input vector is greater than or equal to a threshold. In other words, diffusion engine 110 keeps the synthetic vectors from the neighborhood cloud when the difference between the score generated for the synthetic vector and the score generated for the corresponding input vector meets (e.g., is less than) a predefined threshold. This indicates that there is minimal impact on the predictions made by the first machine learning model 120 based on the input vector and the corresponding synthetic vector.

Referring to the vector distribution 300 in FIG. 3, the vectors 308 are shown as a subset of the neighborhood vectors 302 that fall within the score difference criteria. In other words, the difference in the score generated for the vectors 308 and the score generated for the original reference vector 304 meets (e.g., is less than) the threshold difference. The remaining vectors from the neighborhood vectors 302 that are not the vectors 308 are filtered out. The vectors 308 may be further filtered.

Among these remaining vectors 308, the diffusion engine 110 determines a measure of the maximum absolute multi-variate gradient movement and uses the measure to select a first vector from the remaining vectors 308 with the largest absolute residual value (L). In other words, the diffusion engine 110 further filters the plurality of synthetic vectors (e.g., the vectors 308) by at least identifying a synthetic vector 312 (see FIG. 3) of the plurality of synthetic vectors having a highest absolute residual value (L) among the plurality of synthetic vectors for each input vector (e.g., the reference vector 304 in this example). The synthetic vector having the highest absolute residual value indicates a boundary of a data manifold associated with each input vector. The boundary indicates a maximum stretch of the feature space manifold.

In some implementations, the diffusion engine 110 determines an angle and/or distance between the synthetic vector 312 and the remaining synthetic vectors 308 that meet the difference threshold. The angle and/or distance may be a cosine distance within the feature space. Based at least on the distance (e.g., cosine distance), the diffusion engine 110 may derive the angle (a) between the vectors (e.g., the synthetic vector 312 and each of the remaining synthetic vectors 308). The diffusion engine 110 may compare the derived angles (a) to a threshold angle A. The diffusion engine 110 may further filter the remaining vectors 308 by, for example, ignoring the vectors 308 having an angle that fails to meet (e.g., is less than) the threshold angle. In other words, the diffusion engine 110 filters out the remaining vectors 308 having an angle that fails to meet the threshold angle and keeps the vectors 308 having an angle that meets (e.g., is greater than or equal to) the threshold angle.

In some implementations, the diffusion engine 110 selects one or more synthetic vectors from the remaining vectors that meet both the score threshold and the angle threshold for inclusion in the filtered plurality of counterfactual synthetic vectors used (alone or with the input vectors) to train the second machine learning model 125. For example, the diffusion engine 110 may rank the remaining synthetic vectors that meet both the score threshold and the angle threshold based at least on a size of the angle. The remaining synthetic vectors may be ranked in descending order.

Based at least on the ranked vectors, the diffusion engine 110 may iteratively attempt to select at least one vector for inclusion in the filtered plurality of counterfactual synthetic vectors used to train the second machine learning model 125. In some implementations, the machine learning engine 110 iteratively attempts to select between M-1 and zero vectors, where M is selectable (e.g., predetermined). Including the L (see synthetic vector 312 in FIG. 3), for each original reference vector 304, a maximum of M and minimum of 1 counterfactual synthetic vectors can be selected for inclusion in the filtered plurality of counterfactual synthetic vectors used to train the second machine learning model 125. Referring to FIG. 3, the vectors 310 have been selected for inclusion in the filtered plurality of counterfactual synthetic vectors. The vectors 310 include the maximum synthetic vector 312. In this example, the vectors 310 also include two vectors that meets both the score threshold (e.g., as compared to the vector 304) and the angle threshold (e.g., relative to the maximum synthetic vector 312).

Additionally and/or alternatively, after selecting a synthetic vector based on a maximum distance (e.g., cosine distance and/or angle) from the maximum synthetic vector 312, the machine learning engine 110 may use the selected synthetic vector as a new reference vector from which distances (e.g., cosine distances) are based, and those vectors with the highest angles and/or distances, and/or those vectors with angles and/or distances meeting the threshold angle may be added to the filtered plurality of counterfactual synthetic vectors used for training the second machine learning model 125. This new vector added, then becomes the new reference vector and the process continues.

The diffusion and filtering (e.g., selection) process described herein captures counterfactual vectors where the most significant movement in feature space have little to no change in the prediction made by the initial machine learning model 120. If, for a particular reference input vector (e.g., the input vector 304 shown in FIG. 3), no generated synthetic vectors meet at least the score threshold, no new counterfactual synthetic vectors for that particular reference input vector may be added to the data corpus for training the second machine learning model 125.

Accordingly, multi-variate counterfactual diffusion explores the fundamental data surfaces based on how the first machine learning model 120 would assign outcomes and by exploring the cloud of vectors the manifold of the model in the prediction space is traced out. This approach emphasizes movement in some features as not significant. This process may also allow all features to vary based on the diffusion process and assigns counterfactual vectors involving no change or minimal change in the initial model outcome despite significant variation in the feature values of the generated synthetic vectors compared to the corresponding input vector. In doing so, the diffusion engine 110 desensitizes the training of the second machine learning model 125 given accentuation of manifold sampling in prediction space. This creates a new hardened training dataset deemphasizing irrelevant behaviors in the variations of feature values based on the manifold behavior of the initial machine learning model 120.

Referring back to FIG. 2, at 206, the diffusion engine 110 may fit the second machine learning model 125 (e.g., counter-factual diffusion network). For example, the diffusion engine 110 may fit the second machine learning model 125 based on the filtered plurality of counterfactual synthetic vectors. In other words, the diffusion engine 110 may fit the second machine learning model 125 based on the hardened and augmented data generated in step 204. Here, the second machine learning model 125 may include the same feature set and/or training hyperparameters as the first machine learning model 120. However, the second machine learning model 125 is trained based on both the original input data (e.g., input vectors) and supplemented with the generated filtered plurality of counterfactual synthetic data (e.g., counterfactual synthetic vectors). This allows the manifolds of the first machine learning model 120 to be learnt given sampling along the prediction manifold and improves the performance and accuracy of the second machine learning model 125.

Consistent with implementations of the current subject matter, the diffusion engine 110 may use the second machine learning model 125 to predict a classification of at least one input vector and/or at least one filtered synthetic vector. As a result, the diffusion engine 110 may train the second machine learning model 125 based on a larger quantity of high quality data vectors (including both the input vectors and synthetic vectors), resulting in improved model performance, efficiency, and/or accuracy.

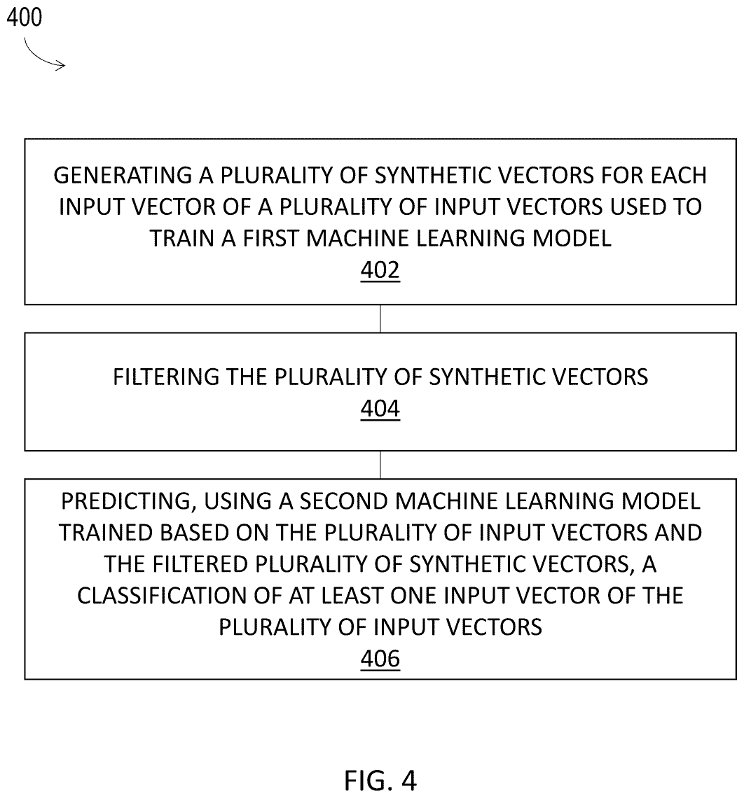

FIG. 4 depicts a flowchart illustrating a process 400 for multi-variate counterfactual diffusion. Referring to FIGS. 1-4, one or more aspects of the process 400 may be performed by the diffusion system 100, the diffusion engine 110, other components therein, and/or the like.

At 402, the diffusion engine 110 may generate a plurality of synthetic vectors for each input vector of a plurality of input vectors used to train a first machine learning model 120. The first machine learning model 120 may be a deep learning network, such as a neural network, among other machine learning models. In some implementations, prior to generating the plurality of synthetic vectors, the diffusion engine 110 may train the first machine learning model 120 based on the plurality of input vectors. The diffusion engine 110 may train the first machine learning model 120 to generate a score and/or classify the plurality of input vectors. As described herein, depending on the application, the plurality of input vectors may represent an input data set of small size and/or with small class representation.

The diffusion engine 110 may generate the plurality of synthetic vectors based on a Gaussian distribution associated with each input vector. In some implementations, the plurality of synthetic vectors may represent potential counterfactuals associated with a corresponding input vector of the plurality of input vectors. Additionally and/or alternatively, only the filtered plurality of counterfactual synthetic vectors may represent counterfactuals. Consistent with implementations of the current subject matter, the counterfactuals may represent new training vectors (e.g., the synthetic vectors) that augment the feature space manifold of the first machine learning model 120 with no (or minimal) change in prediction outcome compared with the original input vector around which the counterfactual synthetic vectors were produced. In other words, the generated counterfactual synthetic vectors capture changes within data inputs that do not materially impact the prediction generated by the first machine learning model 120 based on the original input vector.

At 404, the diffusion engine 110 may filter the plurality of synthetic vectors. The diffusion engine 110 may filter the plurality of synthetic vectors based at least on a comparison between scores generated by the first machine learning model 120 based on an input vector of the plurality of input vectors and each synthetic vector of the plurality of synthetic vectors corresponding to the first input vector. In some implementations, the filtering results in the remaining filtered plurality of counterfactual synthetic vectors representing counterfactuals. For example, the plurality of synthetic vectors may be filtered to identify counterfactual synthetic vectors from the plurality of synthetic vectors.

As an example, the diffusion engine 110 may filter the plurality of synthetic vectors based at least on a comparison between a first score generated by the first machine learning model 120 based on a first input vector of the plurality of input vectors and a second score generated by the first machine learning model 120 based on a first synthetic vector of the plurality of synthetic vectors corresponding to the first input vector. For example, the diffusion engine 110 may generate, via the first machine learning model 120, and based at least on the reference input vector, the first score. The diffusion engine 110 may also generate, via the first machine learning model 120, and based at least on the first synthetic vector, the second score. The diffusion engine 110 may determine a difference between the first score and the second score.

Additionally and/or alternatively, the diffusion engine 110 may filter the plurality of synthetic vectors by at least determining to include particular synthetic vectors in a filtered plurality of counterfactual synthetic vectors based at least on the determined score difference between the reference vector and each synthetic vector from the plurality of synthetic vectors (e.g., scores are determined by the first machine learning model 120 and based on an input vector) and the second score (e.g., determined by the first machine learning model 120 and for each synthetic vector generated for the input vector). For example, the diffusion engine 110 may determine to include synthetic vectors in the filtered plurality of counterfactual synthetic vectors based at least on the score difference being less than or equal to a pre-defined threshold. The determined difference meeting the threshold difference may indicate that the particular synthetic vectors cause no or minimal change in the prediction determined by the first machine learning model 120 based on the corresponding reference vector.

In some implementations, the diffusion engine 110 further filters the plurality of synthetic vectors by at least identifying a synthetic vector of the plurality of synthetic vectors having a highest absolute residual value among the plurality of synthetic vectors for each reference vector. The synthetic vector having the highest absolute residual value indicates a boundary of a data manifold associated with each input vector. In some implementations, the diffusion engine 110 further determines to include additional synthetic vectors in the filtered plurality of counterfactual synthetic vectors based at least on an angle between the synthetic vectors and the synthetic vector having the highest absolute residual value.

In some implementations, the diffusion engine 110 further filters the plurality of synthetic vectors by at least iteratively determining to include a synthetic vector of the plurality of synthetic vectors for each input vector in the filtered plurality of counterfactual synthetic vectors until a threshold quantity of synthetic vectors is included in the filtered plurality of counterfactual synthetic vectors. The included first synthetic vector may be a counterfactual synthetic vector. This helps to ensure that a sufficient quantity of high quality data is added to the initial plurality of input vectors.

At 406, the diffusion engine 110 may predict a classification of at least one input vector of the plurality of input vectors. The diffusion engine 110 may predict the classification via a second machine learning model 125 trained based on the plurality of input vectors and the filtered plurality of counterfactual synthetic vectors. The second machine learning model 125 may be a deep learning network, such as a neural network, among other machine learning models. In some implementations, prior to predicting the classification, the diffusion engine 110 may train the second machine learning model 125 based on the plurality of input vectors and the filtered plurality of counterfactual synthetic vectors. The diffusion engine 110 may thus train the second machine learning model 125 to generate a score and/or classify the plurality of input vectors and/or the filtered plurality of counterfactual synthetic vectors. As a result, the diffusion engine 110 may train the second machine learning model 125 based on a larger quantity of high quality data vectors, resulting in improved model performance, efficiency, and/or accuracy.

### Example Experiments

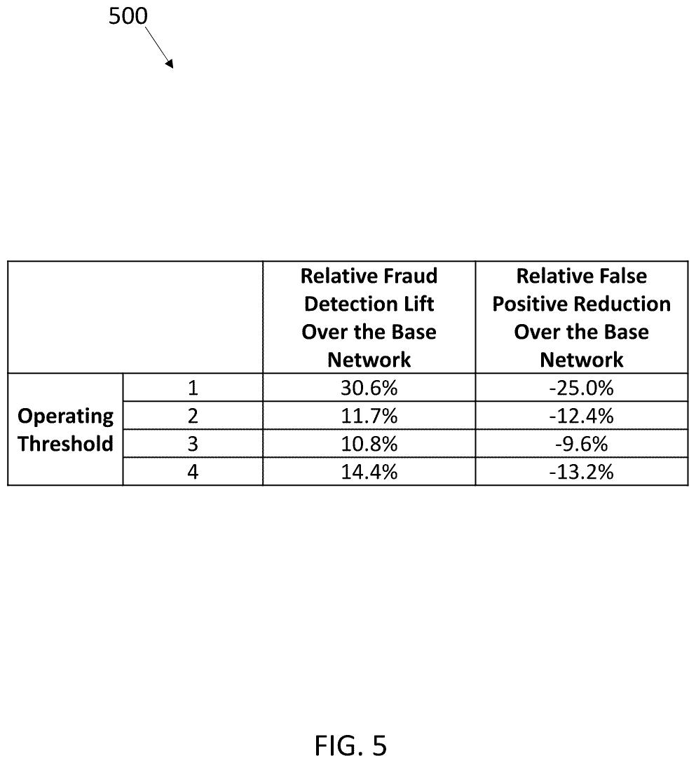

FIG. 5 illustrates a table 500 showing a performance comparison between the diffusion system 100 consistent with implementations of the current subject matter and a conventional model trained only on available input vectors (e.g., without the generated counterfactual synthetic vectors). As shown in the table 500, the machine learning model (e.g., the second machine learning model 125) built using the diffusion system 100 outperformed the base network (e.g., the first machine learning model 120 trained only on available input vectors), detecting more fraud at a transaction level while impacting fewer good customers at the same time. The second machine learning model showing improved results was generated and/or trained using the process described herein, such as the process 200 and/or the process 400, consistent with implementations of the current subject matter.

In this example, the plurality of input vectors (e.g., original training data corpus D) used to train the base network included 93,211 training input vectors. These training input vectors included 91,557 “non-fraud” and 1,654 “fraud” exemplars in a twenty-dimensional feature space. This data represented real banking transactions and was used to train a L2-norm regularized neural network (e.g., the base network) with one output layer and two hidden nodes. The base network was trained for 100 epochs using backpropagation, where the prediction errors were calculated by a cross-entropy loss function. Further hyperbolic tangent (tanh) was used both at the hidden and output layer as the activation function.

As part of the diffusion process (e.g., see step 204 in FIG. 2), for each input vector from D, a neighborhood cloud of 100,000 new synthetic vectors was generated. These synthetic vectors were sampled from a multi-variate Gaussian distribution and used to fit a local linear regression model. The linear least squares loss function was used in fitting the linear model, and regularization was provided by the L2-norm. To filter the generated synthetic vectors, raw tanh score differences between each original reference vector and all the new corresponding synthetic vectors from the neighborhood cloud were calculated using the base network. Of the generated synthetic vectors, only vectors within a specified score difference threshold were included for further filtering. To further filter the remaining synthetic vectors meeting the threshold score difference, a vector with the highest absolute residual (L) value was identified using the local linear regression model to calculate the maximum absolute multi-variate gradient movement in the feature space and to determine the maximum stretch of the data manifold.

To further filter the generated synthetic vectors, a cosine distance between L and the filtered synthetic vectors meeting the specified score difference threshold and angles (α) between the vectors were derived. Based on the angles α, only the vectors with an angle α meeting (e.g., being greater than or equal to) a 45 degree threshold were included in the filtered plurality of counterfactual synthetic vectors, and ranked in a descending order. Among the ranked vectors, the diffusion engine 110 iteratively selected between zero and four vectors. Including the L vector, for each original reference vector, a maximum of five and minimum of one counterfactual synthetic vector was selected. This diffusion process generated a new training data set with 209,841 training vectors (208,010 “non-fraud” and 1,831 “fraud” exemplars), which included both the input vectors and the generated counterfactual synthetic vectors for each of the input vectors.

The diffusion engine 110 then fitted a second machine learning model (e.g., the second machine learning model 125). For example, the diffusion engine 110 trained the new neural network (e.g., second machine learning model 125) using the input vectors and the filtered counterfactual synthetic vectors. The network's architecture and training parameters remained the same as the base network.

The performance of the base network and the newly trained network (denoted as a “counterfactual diffusion network”) was compared. For the comparison, four production model operating thresholds were selected. These thresholds represent typical risk levels that global financial institutions are willing to accept when increasing transaction fraud detection without causing excessive customer friction and without impacting a large quantity of good customers. As noted, the table 500 shows the improved performance of the counterfactual diffusion network at every operating threshold, as evaluated on out-of-time data sample.

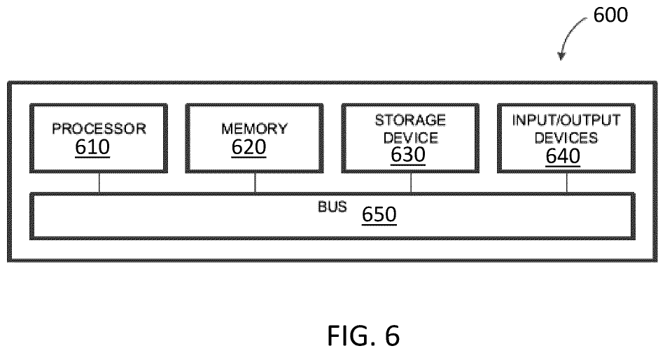

FIG. 6 depicts a block diagram illustrating a computing system 600 consistent with implementations of the current subject matter. Referring to FIGS. 1-6, the computing system 600 can be used to implement the diffusion system 100, the diffusion engine 110, the first machine learning model 120, the second machine learning model 125, and/or any components therein.

As shown in FIG. 6, the computing system 600 can include a processor 610, a memory 620, a storage device 630, and input/output devices 640. The processor 610, the memory 620, the storage device 630, and the input/output devices 640 can be interconnected via a system bus 650. The computing system 600 may additionally or alternatively include a graphic processing unit (GPU), such as for image processing, and/or an associated memory for the GPU. The GPU and/or the associated memory for the GPU may be interconnected via the system bus 650 with the processor 610, the memory 620, the storage device 630, and the input/output devices 640. The memory associated with the GPU may store one or more images described herein, and the GPU may process one or more of the images described herein. The GPU may be coupled to and/or form a part of the processor 610. The processor 610 is capable of processing instructions for execution within the computing system 600. Such executed instructions can implement one or more components of, for example, the diffusion system 100, the diffusion engine 110, the first machine learning model 120, the second machine learning model 125, and/or the like. In some implementations of the current subject matter, the processor 610 can be a single-threaded processor. Alternately, the processor 610 can be a multi-threaded processor. The processor 610 is capable of processing instructions stored in the memory 620 and/or on the storage device 630 to display graphical information for a user interface provided via the input/output device 640.

The memory 620 is a computer readable medium such as volatile or non-volatile that stores information within the computing system 600. The memory 620 can store data structures representing configuration object databases, for example. The storage device 630 is capable of providing persistent storage for the computing system 600. The storage device 630 can be a floppy disk device, a hard disk device, an optical disk device, or a tape device, or other suitable persistent storage means. The input/output device 640 provides input/output operations for the computing system 600. In some implementations of the current subject matter, the input/output device 640 includes a keyboard and/or pointing device. In various implementations, the input/output device 640 includes a display unit for displaying graphical user interfaces.

According to some implementations of the current subject matter, the input/output device 640 can provide input/output operations for a network device. For example, the input/output device 640 can include Ethernet ports or other networking ports to communicate with one or more wired and/or wireless networks (e.g., a local area network (LAN), a wide area network (WAN), the Internet).

In some implementations of the current subject matter, the computing system 600 can be used to execute various interactive computer software applications that can be used for organization, analysis and/or storage of data in various (e.g., tabular) format (e.g., Microsoft Excel®, and/or any other type of software). Alternatively, the computing system 600 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities or can be standalone computing products and/or functionalities. Upon activation within the applications, the functionalities can be used to generate the user interface provided via the input/output device 640. The user interface can be generated and presented to a user by the computing system 600 (e.g., on a computer screen monitor, etc.).

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. For example, the logic flows may include different and/or additional operations than shown without departing from the scope of the present disclosure. One or more operations of the logic flows may be repeated and/or omitted without departing from the scope of the present disclosure. Other implementations may be within the scope of the following claims.

What is claimed is:

1. A system, comprising:
at least one data processor; and
at least one memory storing instructions, which when executed by the at least one processor result in operations comprising:
generating a plurality of synthetic vectors for each input vector of a plurality of input vectors used to train a first machine learning model, wherein the plurality of synthetic vectors represent potential counterfactuals associated with the corresponding input vector;
filtering the plurality of synthetic vectors based at least on a comparison between a first score generated by the first machine learning model based on a first input vector of the plurality of input vectors and a second score generated by the first machine learning model based on a first synthetic vector of the plurality of synthetic vectors corresponding to the first input vector; and
predicting, using a second machine learning model trained based on the plurality of input vectors and the filtered plurality of counterfactual synthetic vectors, a classification of at least one input vector of the plurality of input vectors.

2. The system of claim 1, wherein the plurality of synthetic vectors are generated based on a Gaussian distribution associated with each input vector.

3. The system of claim 1, wherein the filtering comprises:
generating, by the first machine learning model and based at least on the first input vector, the first score;
generating, by the first machine learning model and based at least on the first synthetic vector, the second score;
determining a difference between the first score and the second score; and
determining to include the first synthetic vector in the filtered plurality of synthetic vectors based at least on the difference between the first score and the second score meeting a threshold difference.

4. The system of claim 3, wherein the filtering further comprises:
identifying a synthetic vector of the plurality of synthetic vectors having a highest absolute residual value among the plurality of synthetic vectors for each input vector, wherein the synthetic vector having the highest absolute residual value indicates a boundary of a data manifold associated with each input vector.

5. The system of claim 4, wherein determining to include the first synthetic vector in the filtered plurality of counterfactual synthetic vectors is further based on an angle between the first synthetic vector and the synthetic vector having the highest absolute residual value meeting a threshold angle.

6. The system of claim 5, wherein the angle is a cosine distance, and wherein the threshold angle is a threshold cosine distance.

7. The system of claim 1, wherein the filtering comprises: iteratively determining to include a synthetic vector of the plurality of synthetic vectors for each input vector in the filtered plurality of counterfactual synthetic vectors until a threshold quantity of synthetic vectors is included in the filtered plurality of counterfactual synthetic vectors.

8. The system of claim 1, wherein the operations further comprise training the first machine learning model based on the plurality of input vectors; and training the second machine learning model based on the plurality of input vectors and the filtered plurality of counterfactual synthetic vectors.

9. The system of claim 1, wherein the first machine learning model is a first neural network, and wherein the second machine learning model is a second neural network.

10. A method, comprising:
generating a plurality of synthetic vectors for each input vector of a plurality of input vectors used to train a first machine learning model, wherein the plurality of synthetic vectors represent potential counterfactuals associated with the corresponding input vector;
filtering the plurality of synthetic vectors based at least on a comparison between a first score generated by the first machine learning model based on a first input vector of the plurality of input vectors and a second score generated by the first machine learning model based on a first synthetic vector of the plurality of synthetic vectors corresponding to the first input vector; and
predicting, using a second machine learning model trained based on the plurality of input vectors and the filtered plurality of counterfactual synthetic vectors, a classification of at least one input vector of the plurality of input vectors.

11. The method of claim 10, wherein the plurality of synthetic vectors are generated based on a Gaussian distribution associated with each input vector.

12. The method of claim 10, wherein the filtering comprises:
generating, by the first machine learning model and based at least on the first input vector, the first score;
generating, by the first machine learning model and based at least on the first synthetic vector, the second score;
determining a difference between the first score and the second score; and
determining to include the first synthetic vector in the filtered plurality of synthetic vectors based at least on the difference between the first score and the second score meeting a threshold difference.

13. The method of claim 12, wherein the filtering further comprises:
identifying a synthetic vector of the plurality of synthetic vectors having a highest absolute residual value among the plurality of synthetic vectors for each input vector, wherein the synthetic vector having the highest absolute residual value indicates a boundary of a data manifold associated with each input vector.

14. The method of claim 13, wherein determining to include the first synthetic vector in the filtered plurality of counterfactual synthetic vectors is further based on an angle between the first synthetic vector and the synthetic vector having the highest absolute residual value meeting a threshold angle.

15. The method of claim 14, wherein the angle is a cosine distance, and wherein the threshold angle is a threshold cosine distance.

16. The method of claim 10, wherein the filtering comprises: iteratively determining to include a synthetic vector of the plurality of synthetic vectors for each input vector in the filtered plurality of counterfactual synthetic vectors until a threshold quantity of synthetic vectors is included in the filtered plurality of counterfactual synthetic vectors.

17. The method of claim 10, further comprising training the first machine learning model based on the plurality of input vectors; and training the second machine learning model based on the plurality of input vectors and the filtered plurality of counterfactual synthetic vectors.

18. The method of claim 10, wherein the first machine learning model is a first neural network, and wherein the second machine learning model is a second neural network.

19. A non-transitory computer-readable medium storing instructions, which when executed by at least one data processor, result in operations comprising:
generating a plurality of synthetic vectors for each input vector of a plurality of input vectors used to train a first machine learning model, wherein the plurality of synthetic vectors represent potential counterfactuals associated with the corresponding input vector;
filtering the plurality of synthetic vectors based at least on a comparison between a first score generated by the first machine learning model based on a first input vector of the plurality of input vectors and a second score generated by the first machine learning model based on a first synthetic vector of the plurality of synthetic vectors corresponding to the first input vector; and
predicting, using a second machine learning model trained based on the plurality of input vectors and the filtered plurality of counterfactual synthetic vectors, a classification of at least one input vector of the plurality of input vectors.

20. The non-transitory computer-readable medium of claim 19, wherein the plurality of synthetic vectors are generated based on a Gaussian distribution associated with each input vector.
